(19) United States
(12) Patent Application Publication
(10) Pub. No.: US 2020/0274253 A1
(43) Pub. Date: Aug. 27, 2020

(54) PLUG AND PLAY HIGH PERFORMANCE OMNI COVERAGE HDTV ANTENNA

(71) Applicants: Gary Gwoon Wong, Torrance, CA (US); Kalem Gwoon Wong, Rancho Palos Verdes, CA (US); Samuel Wahon Wong, Rancho Palos Verdes, CA (US)

(72) Inventors: Gary Gwoon Wong, Torrance, CA (US); Kalem Gwoon Wong, Rancho Palos Verdes, CA (US); Samuel Wahon Wong, Rancho Palos Verdes, CA (US)

(21) Appl. No.: 16/560,100

(22) Filed: Sep. 4, 2019

Related U.S. Application Data
(60) Provisional application No. 62/917,992, filed on Jan. 11, 2019.

(51) Int. Cl. H01Q 21/06; H01Q 1/24; H01Q 1/38; H01Q 1/48

(52) U.S. Cl. CPC H01Q 21/062; H01Q 1/241; H01R 12/53; H01Q 1/48; H01Q 1/38

(57) ABSTRACT

A highly efficient radiation structure in a compact design is described. The structure is designed to receive over the air signals in the UHF frequency band. Unlike most of the current structures, the disclosure structure consists of an array of four radiating elements and are configured to perform an uniform reception along the horizontal plane and the elements are positioned in a circle or in a square configuration and are located near the outer edge of a circular or a square shape circuit board; the elements are efficiently combined by an unique four way power combiner which is specially designed to obtain the necessary impedance match to an input coaxial cable. The entire structure consist only a few simple parts. Namely, a circuit board with the top and bottom surfaces etched on with the radiating elements and associated feed lines. A coaxial feed line terminated with a feeding connector of the F type is provided. This coaxial line provides the necessary input connection to the circuit board and also routs the receiving signal to a TV. Two circuit board designs are disclosed; one is equipped with circular dipole arms while the second circuit board is equipped with the rectangular dipole arms. On the circular dipole element design, the array structure is implemented with a cone shape ground plane which is designed to help reduce the radiation coverage below the horizons. The square aperture array is implemented without the cone shape ground plane. Both structures are protected by a plastic enclosure and both structures are configured to be simple and can be made economically.

### CROSS-REFERENCE TO RELATED APPLICATION

This application claims the benefit of the U.S. Provisional Application No. 62/917,992 filed on Jan. 12, 2019. The substitute specification contains no new matters.

### SUMMARY OF THE INVENTION

A highly compact symmetrical structure is disclosed. The subject structure is designed to maximize the reception capability of the structure to receive over the air signals.

Structures in used today are unable to achieve a desire reception. The radiation coverages are often too broad or too narrow.

The broad coverage structure has the advantage of receiving signals from all the surrounding-stations. However, the gain performance of the broad coverage structure is inherently low and often unable to receive signals from far away stations.

The narrow coverage antenna, on the other hand, has the inherent high gain performance advantage and is able to receive the over air signal from a greater distance away. The short fall is that the reception capability is reduced due to its narrower beam coverage.

Generally, the high gain antennas for HDTV reception are either log-periotic or Yagi designs and has a typical gain performance of 10 DBIL The physical size is generally very large due to the low operating frequency of UHF band and the wavelength is long, and as a result the physical size is very large. Most the high gain structures are located outdoor on the top of a roof.

The indoor radiation structures are of a broad coverage nature and the gain is typically 3 DBIL.

The Wongs' U.S. Pat. No. 8,773,322 B2 and U.S. Pat. No. 9,343,798 B2 antennas are also of low gain designs but the physical sizes have been reduced substantially. Both referenced antennas are not only small in physical size and they are having an exceptional broad impedance performance and the efficiency is extremely high.

The disclosure antenna structure describe here is very different from the referenced antennas because the emphasis has been to obtain an uniform coverage along the horizontal plane which enable the antenna to operate inside the house with easy and any miner change of the antenna orientation to help obtain a stable reception is not necessary.

One of a main goal in the design of the disclosure antenna is to simplify the antenna structure such it can perform with easy and special instruction and adjustment would not be needed. It should be noted that the physical appearance and construction of the two referenced disclosure antennas are not the same as the current disclosure structure. The referenced antennas are of a single element device while the current disclosure antenna is a multi-elements device and has also a uniform radiation coverage along the horizontal plane over the upper hemisphere.

Initially, the disclosure antenna was designed to receive HDTV programs for a moving vehicle; it was later learned that the current TV system is designed for stationary TV reception and the system can only perform TV reception on a moving vehicle for a speed of 15 mph. Despite this system short fall, the antenna design is very desirable for viewing sport events in a tailgate party on a recreation vehicle or around any living space, because the setup of the antenna for TV reception Is extremely simple and it can be accomplished with easy while positioning and adjustment of the antenna are not required.

### DETAILED DESCRIPTION

The disclosure antenna composes of eight rectangular or round radiating arms with four arms located on the top surface of a circuit board and the opposing four arms are located on the back side surface of the circuit board. The arms are spaced evenly along the four quadrants of a circle or along the four quadrants of a square circuit board. The arms are made very wide which are designed to accommodate a broad frequency bandwidth of 400 to 800 MHz and the impedance match is uniquely accomplished through the joining of the two intersecting transmission lines connecting to the top and bottom surface of circuit board radiating elements at the center of the board via a coaxial cable.

The outer copper shield of the coaxial cable is soldered to the opposing bottom of the circuit board while the center conductor of the coaxial cable is soldered to the top part of the circuit board at the center of the radiating elements.

All the interconnecting parts are working together to achieve the desired broad band impedance performance of the system. The entire groups of dipole elements are excited simultaneously and as the result a uniform coverage radiation is achieved along the horizontal plane.

With the help of the conical ground plane which is located below the dipole radiating element, the radiation of the circular element design below the horizon is minimized.

The gain of the disclosure antenna is estimated to be 3 DBIL. By stacking four of array boards, half wavelength separation, one can obtain an antenna gain of 8.5 DBIL. FIG. 1d is the side view of the high gain stacking four elements array antenna.

### DRAWINGS

The disclosure structure comprise of four major parts. Namely, the circuit board, the conical ground plane, the excitation coaxial cable and the structure enclosure. It should be noted that the dimensions provide below are configured for a center frequency of 600 Mhzs. The dimensions should be adjusted accordingly for other frequency of design.

FIG. 1—Circular Array of Curve Dipole Element

FIG. 1a—Top View of Circular Board

FIG. 1a is a circuit board of a preferred embodiment of the subject invention containing a group of four dipole elements 1 which is excited by two intersecting feed lines 2 of 3/16 inches width. The curve rectangular arms 3 of the dipole elements are measure approximately 1½ by 2¼ inches. The diameter 4 of the circular board containing the four element array is measured approximately 5¾ inches.

FIG. 1b—Side View of Circular Board

FIG. 1b is a side view of circular board containing the circular dipole elements which are excited by a coaxial cable 5 and the end of the cable is terminated by F connector 6. The center conductor of the coaxial cable 7 is soldered to the dipole arms on the top of the circuit board while the outer coaxial shield 8 is soldered to the dipole arms on the backside of the board.

FIG. 1c—Side View of Circular Board Array

FIG. 1c is the side view of a Circular Board Array. The enclosure is a cylindrical body fabricated by cutting a plastic pipe to a desire length and the two ends are enclosed by a round piece of plastic disk which are rigidly bonded to the cylindrical enclosure. The outer diameter of the cylinder 9 is measured approximately 6¼ inches. Below the circular circuit board is a conical cone ground plane which is implemented to help shape the elevation radiation coverage of the radiating structure. The diameter of the cone 10 is measured approximately 6 inches. The cone is fabricated by folding a round copper metal disk into a cone with a cone angle 11 approximately 90 degrees and a diameter 12 of approximately 6 inches.

FIG. 1d—Array of 4 Circular Arrays of Curve Element

FIG. 1d is a side view of an array composed 4 Circular Array Radiating Structures; it is designed to obtain additional antenna gain of approximately 5½ dBs. The four radiating structures is obtained by stacking four circular array on the top of each other and are excited by an equal power division four ways power divider and are protected by a RF transparent cover. The power divider is not shown. The outer dimensions of the enclosure 13 is measured approximately 6¼×6¼×20 inches. The total gain of FIG. 1d Array is estimated to be 8½ dBil. This antenna structure can be mounted on an outdoor post for receiving greater distance signals much like today outdoor antennas of lo-periodic and Yagi antennas but in a smaller profile.

FIG. 2—Square Array of Rectangular Element

FIG. 2a—Square Array Radiating Structure

FIG. 2a is a prospective view of the square array. The elements are located on a square circuit board and the dipole arms are rectangular shape and the dimensions of the rectangular arms are 1.5 inches wide and 3.0 inches long. The stripe transmission lines 15 connecting the rectangular shape dipole arms of the array elements are measured 3/16 inches. The array composes of four dipole elements; half the dipole arms are located on the top outer edges of the square board FIG. 2aa and the opposing half is located on the back side of the board FIG. 2ab. The circuitry on two sides of the board are excited by a coaxial cable 16 of RG58/U and terminated by an F type of connector. The center conductor of the coaxial cable is soldered to the top side circuits 17 while the copper shields of the coaxial cable outer part 18 is soldered to the bottom circuits (FIG. 2b).

FIG. 2c—Square Array Enclosure

FIG. 2c is the side view of the square array protected by a plastic enclosure. The enclosure 19 is fabricated by bonding ABC material of ⅛ inches thickness ABC pieces. The outer dimensions of the Enclosure are measured approximately 6×6×1.5 inches.

1. A highly efficient radiation structure in a compact design is disclosed; the structure composed of an array of four radiating elements and are configured to perform a uniform reception along the horizontal plane; the embodiment of the radiating elements are positioned in a circle or in a square layout on a circuit board and the radiating elements are located near the outer edges of the board; the elements are efficiently combined by an unique four ways power combiner which is specially designed to combine the radiating elements without the use of interconnecting parts such as coaxial cables and connectors; the entire structure consists of only few parts, namely, a circuit board with the top and bottom surfaces etched on with its radiating elements and its associated interconnecting transmission lines; a coaxial cable terminated with a F-type connector is provided and the coaxial cable is designed help routing the array structure signals to a TV or to other communication devices; two circuit boards designs are disclosed and one of the circuit board is of circular shape while the second design is a square shape; the circular shape design is implemented with a conical ground plane to help shaping the elevation coverage of the array while the square shape board design is implemented without a conical ground plane; the positioning of the disclosure structure for reception of over the air signal is very forgiven and the unit can be positioned by laying the unit flat on a support structure or in its side way position; the disclosure units are protected by a plastic enclosure of ABC material;

2. The structure described in claim 1 consists a group of four radiating elements of either circular or rectangle dipole arms which are itched on a circular or a square circuit board;

3. The length to width ratio of the claim 2 dipole arms is approximately 2:1; the dipole arms are separated approximately 0.25 wavelength; the width and length of the dipole arms are selected to provide the desired impedance match for the array; a good impedance match dimensions for UHF band is approximately 3.0 inches in length and 1.5 inches in width

4. The circuit board outer dimension for claim 1 disclosure antenna unit is configured for UHF frequencies and measuring approximately 6.00 inches and the dimensions of other design frequency may be obtained by frequency scaling;

5. The radiating elements of the claim 1 disclosure array are located near the outer edge of the circuit board;

6. The claim 1 disclosure antenna whose radiating elements are combined efficiently without the use of interconnecting parts such as coaxial cables and connectors;

7. The claim 1 disclosure structure is implemented with a coaxial cable and the coaxial cable is terminated with a F-type connector which is designed for routing of receiving signals from the array to TV or to a communication device;

8. The claim 1 disclosure identified two shapes of circuit boards which can be implemented; one is circular shape while the other one is square shape; the circular board is implemented with a conical ground plane; the square shape board is implemented without a cone shape ground plane;

9. The claim 1 disclosure antenna can be operated in multiple positions; it can be placing by facing the unit upward or in a sideway orientation; the unit is very forgiven and for this reason a plug and play name is applied to emphasize the forgiveness feature of the design;

10. The claim 1 disclosure structure is protected by a plastic enclosure. The enclosure 19 is fabricated by bonding ABC material of ⅛ inches thickness board pieces. The outer dimensions of the enclosure are measured approximately 6×6×1.5 inches;

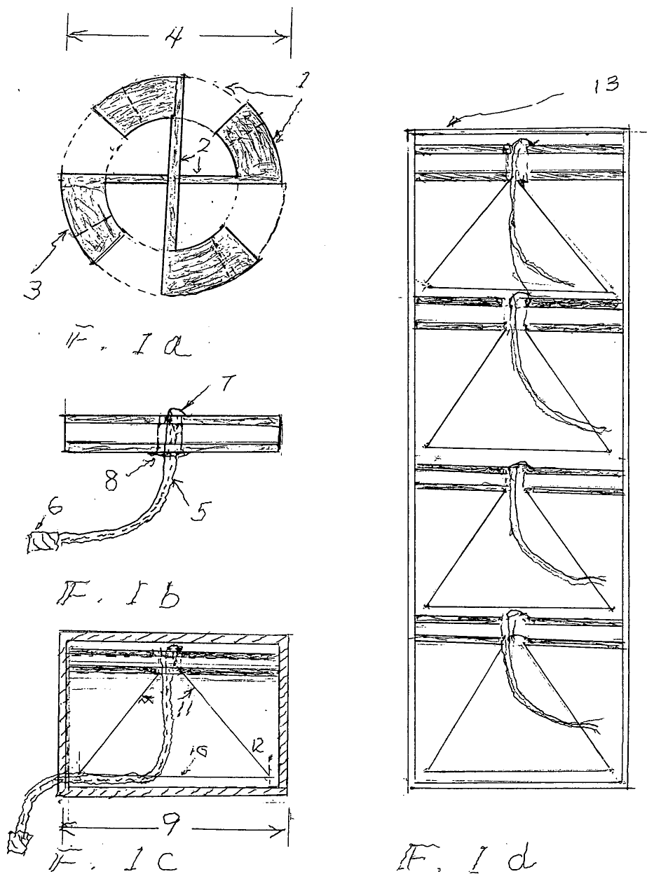

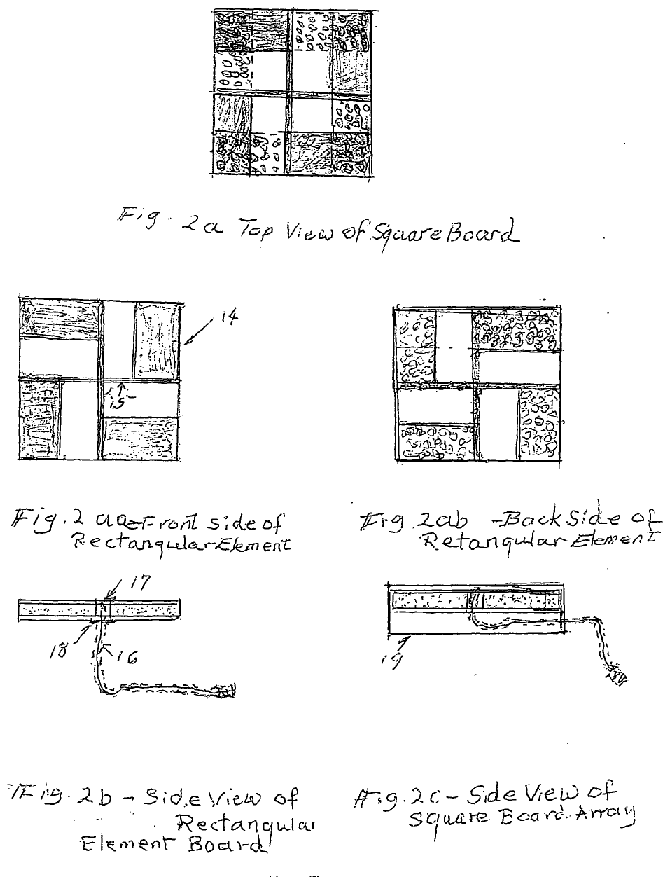

11. FIG. 1d antenna structure is a good candidate to replace the current outdoor antennas of the log-periodic and Yagi designs; the design is also applicable as a router antenna for future 5g system involving handheld devices.
